(19) United States
(12) Patent Application Publication
(10) Pub. No.: US 2007/0071945 A1
(43) Pub. Date: Mar. 29, 2007

(54) System and method for forming gloss and matte transparent labels from a common film and emulsion set

(76) Inventors: Wesley R. Schalk, Camas, WA (US); M. Lynn Cheney, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/239,874

(22) Filed: Sep. 29, 2005

(51) Int. Cl. G11B 5/64

(52) U.S. Cl. 428/141

(57) ABSTRACT

A method of forming a label includes providing a film having a smooth surface and a textured surface, and selectively coating one surface of the film with an ink receptive emulsion to form a glossy or a matte label.

### BACKGROUND

Optical discs have become an industry standard for data storage in the fields of computers, videos, pictures, games, and music, for example. Optical discs include, but are not limited to, compact discs (CDs), digital video (or versatile) discs (DVDs), and game system discs in a variety of formats. Commercially produced optical discs usually have digital data recorded on one side of the disc and a visual display printed on the other side of the disc.

In some instances, optical discs are created that can store data on both sides of the disc. However, in many cases, it is desirable to limit the optical disc data to a single side of the disc, leaving the other side of the disc for printed text, patterns, or graphics. The printed labeling on a non-data side of an optical disc can include a decorative design, text, or both.

As optical technology has advanced, writeable and rewriteable optical discs and equipment for writing onto the discs have become reasonably priced within the grasp of ordinary consumers. Thus, many consumers currently have the ability to store data on an optical disc using home office equipment. However, specialized and expensive equipment is required to print labeling on an optical disc. Consequently, the labeling of discs by most consumers is typically limited to printing on separate adhesive labels that are adhered to the non-data side of the disc or hand-writing with a marker directly on the disc or an adhesive label.

The optical discs used as storage mediums frequently have two sides: a data side configured to receive and store data and a label side. The label side is traditionally a background on which the user hand writes information to identify the disc.

Label images on digitally readable discs can be printed using water-based inks. Further, production of digitally readable discs is increasingly custom or short run requiring digital printing methods such as thermal or piezoelectric inkjet to economically produce labels. Protecting these digitally readable disc label images against abrasion, water, alcohol, other liquid spills, ink smear, fading, blocking or other image-degradation processes and effects has become an important consideration. Such protection is particularly desirable for digitally readable disc label images produced with water-based (water-soluble) or other liquid inks, as well as documents printed or imaged with toner.

### SUMMARY

A system for selectively forming a glossy or a matte label includes an semi-opaque or transparent film having a smooth surface and a textured surface opposing the smooth surface, and a hydrophilic ink receptive emulsion configured to be coated on at least one side of the semi-opaque or transparent film, wherein the film is configured to form a glossy label when the textured surface is coated with the hydrophilic ink receptive emulsion, and wherein the film is configured to form a matte label when the smooth surface is coated with the hydrophilic ink receptive emulsion.

Additionally, according to one exemplary embodiment, a method of forming a label includes providing a film having a smooth surface and a textured surface, and selectively coating one surface of the film with an ink receptive emulsion to form a glossy or a matte label.

### BRIEF DESCRIPTION OF THE DRAWINGS

The accompanying drawings illustrate various embodiments of the present system and method and are a part of the specification. The illustrated embodiments are merely examples of the present system and method and do not limit the scope of the disclosure.

FIG. 1 illustrates an exploded perspective view of the components of an optical disc and label, according to one exemplary embodiment.

FIGS. 2a and 2b are cross-sectional side views illustrating the components of a matte and gloss label respectively, according to various exemplary embodiments.

FIG. 3 is a flowchart illustrating a method of forming a matte label with a common film and emulsion set, according to one exemplary embodiment.

FIG. 4 is a flowchart illustrating a method for forming a gloss label with a common film and emulsion set, according to one exemplary embodiment.

FIG. 5 is a flowchart illustrating a method for printing and applying a common film label, according to one exemplary embodiment.

FIGS. 6a through 6c are cross-sectional side views illustrating the printing of a label and the application of a matte and a gloss label to an optical disc, according to various exemplary embodiments.

Throughout the drawings, identical reference numbers designate similar, but not necessarily identical, elements.

### DETAILED DESCRIPTION

The present exemplary systems and methods provide for the formation and use of a gloss or matte ink imageable transparent label produced from a single film and emulsion set. According to one exemplary embodiment, the present exemplary system and method incorporates a single film having a smooth side and a slightly textured side. By varying which side of the single film the emulsion set is applied, the resulting optical finish of the transparent label may be varied from matte to gloss. Further details of the present label forming system, as well as exemplary methods for forming images on the label and applying the label to a desired substrate will be described in further detail below.

As used in the present specification, and in the appended claims, the term “optical disc” is meant to be understood broadly as including, but in no way limited to, audio, video, multi-media, and/or software discs that are machine readable in a CD and/or DVD drive, or the like. Non-limiting examples of optical disc formats include, writeable, recordable, and rewriteable discs such as DVD, DVD-R, DVD-RW, DVD+R, DVD+RW, DVD-RAM, CD, CD-ROM, CD-R, CD-RW, and the like.

For purposes of the present exemplary systems and methods, the term “emulsion” refers to any number of liquid droplets dispersed in another immiscible liquid. The dispersed phase droplet sizes may range from approximately 0.1 - 10 μm.

Further, as used in the present specification, the term “matte” shall be interpreted broadly as including any surface that lacks luster or gloss and has a usually smooth even surface free from shine or highlights. While gloss labels generally provide a greater initial impression, they also show surface damage such as fingerprints and scratches. In contrast to gloss surfaces, matte finishes typically exhibit a more subdued image, hide imperfections on the surface, and are less susceptible to glare.

In the following description, for purposes of explanation, numerous specific details are set forth in order to provide a thorough understanding of the present systems and methods for forming a gloss or matte transparent label from a common film and emulsion set. It will be apparent, however, to one skilled in the art that the present systems and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

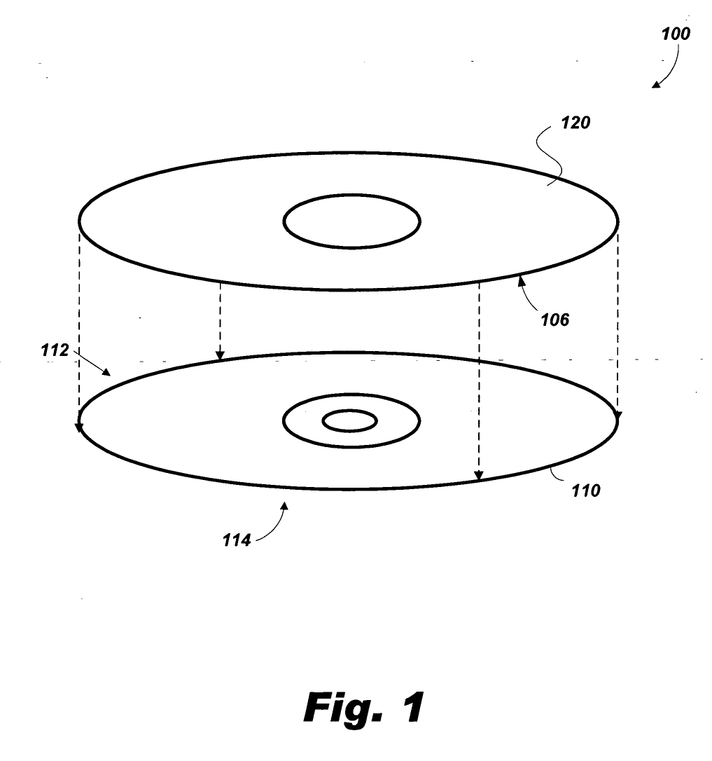

FIG. 1 illustrates a schematic view of an optical disc system (100) including an optical disc (110) and a label (120). As used herein, for ease of explanation only, the present exemplary system and method for forming a gloss or a matte transparent label from a single common film and emulsion set will be described in the context of forming a label for an optical disc system. However, the present systems and methods may be applied to labels for any number of substrates including, but in no way limited to, labels for electronics, printers, copiers, plaques, control pads, and the like.

According to one exemplary embodiment, illustrated in FIG. 1, the optical disc (110) includes a top surface (112) and an opposing bottom surface (114). The bottom surface (114) has a data surface formed thereon configured to store data while the top surface (112) may be free of data and otherwise configured to receive the present exemplary label (120).

With respect to the bottom surface (114) of the optical disc (110), data may be stored thereon, as is well known in the art. As used herein, the term “data” is meant to be understood broadly as including non-graphic information digitally or otherwise embedded on a radiation image-able disc. According to the present exemplary embodiment, data can include, but is in no way limited to, audio information, video information, photographic information, software information, and the like.

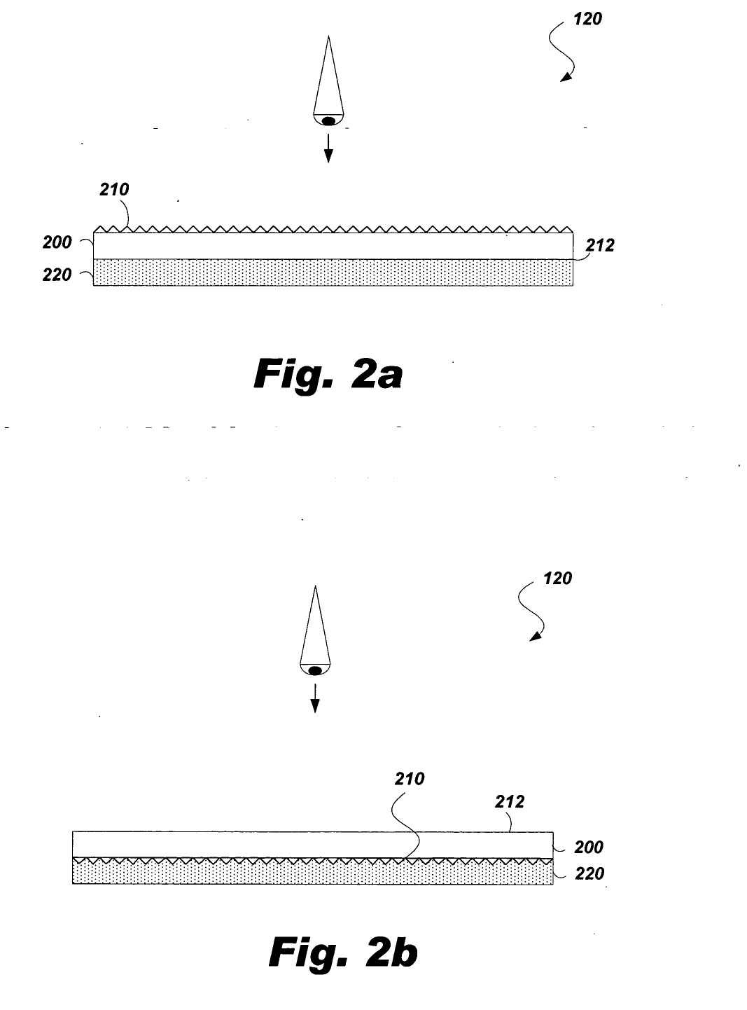

In contrast to the bottom surface (114) of the exemplary optical disc (110), the top surface (112) of the optical disc (110) includes a non-data carrying surface configured to receive the label (120). According to one exemplary embodiment, the label (120) includes an adhesive layer (106) configured to couple the label (120) to the top surface (112) of the optical disc (110). Additionally, according to one exemplary embodiment, the present label (120) is configured to exhibit either a gloss or matte finish when manufactured from a single common film and emulsion set. Further details of the exemplary label (120) will be described in detail below with reference to FIGS. 2a and 2b.

According to one exemplary embodiment, the present label (120) includes a film (200) having a textured side (210) and a smooth side (212). Additionally, a printable emulsion (220) is coupled to a surface of the film (200) to form an inkjet printable label. According to the present exemplary system and method, the surface characteristics of the label (120) may vary from glossy to matte by varying the side of the film (200) that is coated by the printable emulsion (220).

More specifically, as illustrated in FIG. 2a, a printable label (120) having a matte finish is shown, according to one exemplary embodiment. As shown, the printable emulsion (220) is coupled to the smooth side (212) of the film (200) causing the textured side to remain uncoated on the viewable side of the label (120). As a result of leaving the textured side (210) of the film (200) uncoated, light viewed by an observer will be slightly diffracted by the surface irregularities of the textured side (210), causing a resulting image that is placed behind the film (200) to have a matte finish.

In contrast to the printable label (120) having a matte finish, FIG. 2b illustrates a cross-sectional construction of an inkjet printable label that will exhibit a glossy surface finish, according to one exemplary embodiment. As shown, the glossy label (120) includes the same components as the matte label illustrated in FIG. 2a. However, in the glossy inkjet printable label of FIG. 2b, the printable emulsion (220) is coupled to the textured side (210) of the film (200), leaving the smooth side (212) of the film displayed to an observer. According to this exemplary embodiment, the inkjet printable emulsion (220) generously fills the uneven surface of the textured side of the film (200). Consequently, when viewed from the smooth side (212) of the film (200), any image formed on the printable emulsion (220) has a glossy appearance.

As illustrated, both the glossy inkjet printable label illustrated in FIG. 2b and the matte inkjet printable label illustrated in FIG. 2a incorporate identical components, specifically a film (200) with a textured side (210) and a smooth side (212) and an inkjet printable emulsion (200). However, by varying the location of the inkjet printable emulsion (200), the optical surface properties of the label (120) may be varied. Further details of each component of the identified label (120) will be provided below.

Exemplary Film

As mentioned previously, the base for the present exemplary label (120) includes a film (200) having one smooth clear side (212) and a second slightly textured side (210). According to one exemplary embodiment, the film (200) may be formed by an extrusion method. When extruded, the film (200) receives a light texture transferred from the extruding roll, while the top layer forms a smooth clear surface. According to this exemplary embodiment, the slightly textured side (210) may have any number of finishes formed thereon including, but in no way limited to, brushed, velvet, velvet gloss, satin, and the like.

According to one exemplary embodiment, the film (200) may include any number of polymeric films that are visually transparent in at least one region within the visible spectral region and typically is transparent throughout the visible spectral region. According to one exemplary embodiment, the polymeric film is substantially clear or semi-opaque or transparent to view a printed image there through.

Specifically, according to one exemplary embodiment, the film (200) component of the present label (120) is formed of any transparent film that can be manufactured with different surface characteristics on opposing sides including, but in no way limited to, polycarbonate, polyester, polypropylene, or cellulose acetate based films. A number of commercially available polycarbonate films may be used including, but in no way limited to, polycarbonate film 8835 commercially available by GE or BE 1-4D commercially available by Bayer.

According to one exemplary embodiment, the film may also include components which strongly absorb ultraviolet radiation thereby reducing damage to underlying images by ambient ultraviolet light, e.g., such as 2-hydroxybenzophenones; oxalanilides; aryl esters and the like; hindered amine light stabilizers, such as bis(2,2,6,6-tetramethyl-4-piperidinyl) sebacate and the like; and combinations thereof. The web or sheet may also be surface treated or coated with a material to enhance desired surface characteristics, e.g. sub-coatings, electric discharge treatment, and the like.

Ink Jettable Emulsion

Additionally, as illustrated in FIGS. 2a and 2b, the present exemplary label (120) may vary between a glossy and a matte finish by selectively varying the application of an ink receptive emulsion (220). According to one exemplary embodiment, the ink receptive emulsion (220) may be a hydrophilic, aqueous ink sorptive, coating material. Further, the ink receptive emulsion (220) may be visually transparent in at least one region within the visible spectral region and typically is transparent throughout the entire visible spectral region. According to one exemplary embodiment, the ink receptive emulsion (220) may range from fully transparent to fully opaque, depending on the intent of the label. Opacity helps to conceal the underlying substrate, while transparency enables the substrate to become part of the printed image. Further, the opacity of the ink receptive emulsion (220) may change once printed on. The visible spectral region of the ink receptive emulsion (220) may also be matched to that of the film (200).

The ink receptive emulsion (220) may be prepared from a wide variety of hydrophilic, aqueous ink sorptive, coating materials. More specifically, the ink receptive emulsion (220) typically is comprised of at least one hydrophilic polymer or resin which also may be water soluble. Suitable hydrophilic polymers or resins include, but are in no way limited to, polyvinyl alcohols, including substituted polyvinyl alcohols; polyvinyl pyrrolidones, including substituted polyvinyl pyrrolidones; vinyl pyrrolidone/vinyl acetate copolymer; vinyl acetate/acrylic copolymers; acrylic acid polymers and copolymers; acrylamide polymers and copolymers; cellulosic polymers and copolymers; styrene copolymers of allyl alcohol, acrylic acid, malaeic acid, esters or anhydride, and the like; alkylene oxide polymers and copolymers; gelatins and modified gelatins; polysaccharides; and the like. Preferred hydrophilic polymers include polyvinyl pyrrolidone; substituted polyvinyl pyrrolidone; polyvinyl alcohol; substituted polyvinyl alcohol; vinyl pyrrolidone/vinyl acetate copolymer; vinyl acetate/acrylic copolymer; polyacrylic acid; polyacrylamides; hydroxyethylcellulose; carboxyethylcellulose; gelatin; and polysaccharides. The ink receptive emulsion (220) may also contain other water insoluble or hydrophobic polymers or resins to impart a suitable degree of hydrophilicity and/or other desirable physical and chemical characteristics.

Suitable polymers or resins of this class include polymers and copolymers of styrene, acrylics, urethanes, and the like. Preferred polymers and resins of this type include a styrenated acrylic copolymer; styrene/alkyl alcohol copolymer; nitrocellulose; carboxylated resin; polyester resin; polyurethane resin; polyketone resin; polyvinyl butyral resin; or mixtures thereof. In addition to the polymeric or resin components, the ink receptive emulsion (220) typically contains other added components such as a dye mordant, a surfactant, particulate materials, a colorant, an ultraviolet absorbing material, an organic acid, an optical brightener, and the like. Dye mordants which may be used to fix the printed ink to the ink receptive emulsion (220) may be any conventional dye mordant such as polymeric quaternary ammonium salts, polyvinyl pyrrolidone, and the like. Surfactants which are used as coating aids for the ink receptive emulsion (220) may be any nonionic, anionic, or cationic surfactant. Particularly useful are fluorosurfactants, alkylphenoxypolyglycidols, and the like.

The ink receptive layer may also contain particulate material. Such materials are believed to aid in enhancing the smoothness characteristics of the ink receptive emulsion, particularly after it has been printed upon without adversely affecting the transparent characteristics of the element. Suitable particulate material includes inorganic particles such as silicas, chalk, calcium carbonate, magnesium carbonate, kaolin, calcined clay, pyrophylite, bentonite, zeolite, talc, synthetic aluminum and calcium silicates, diatomatious earth, anhydrous silicic acid powder, aluminum hydroxide, barite, barium sulfate, gypsum, calcium sulfate, and the like; and organic particles such as polymeric beads including beads of polymethylmethacrylate, copoly(methylmethacrylate/divinylbenzene), polystyrene, copoly(vinyltoluene/t-butylstyrene/methacrylic acid), polyethylene, and the like. The composition and particle size of the particles are selected so as not to impair the transparent nature of the ink receptive emulsion (220) while effectively filling the uneven surface of the textured side of the film (200) when applied.

The ink receptive emulsion (220) may also contain a colorant, e.g., a dye or pigment, provided the emulsion is visually transparent in at least one region within the visible spectral region and typically is transparent throughout the visible spectral region. This emulsion may contain components which strongly absorb ultraviolet radiation thereby reducing damage to underlying images by ambient ultraviolet light, e.g., such as 2-hydroxybenzophenones; oxalanilides; aryl esters and the like; hindered amine light stabilizers, such as bis(2,2,6,6-tetramethyl-4-piperidinyl) sebacate and the like; and combinations thereof. Organic acids which are used to adjust the pH and hydrophilicity in the ink receptive emulsion (220) typically are non-volatile organic acids such as a alkoxy acetic acid, a glycolic acid, a dibasic carboxylic acid and half esters thereof, a tribasic carboxylic acid and partial esters thereof, aromatic sulfonic acids, and mixtures thereof. Preferred organic acids include glycolic acid, methoxy acetic acid, citric acid, malonic acid, tartaric acid, malic acid, maleic acid, fumaric acid, itaconic acid, succinic acid, oxalic acid, 5-sulfo-salicylic acid, p-toluenesulphonic acid, and mixtures thereof. Optical brighteners which may be used to enhance the visual appearance of the imaged layer may be any conventional, compatible optical brightener, e.g., such as optical brighteners marketed by Ciba-Geigy under the trademark of Tinopal RTM.

As mentioned previously, the present exemplary ink receptive emulsion (220) is configured to be applied to a back side of a film to allow for the formation of a desired image. According to one exemplary embodiment, the present ink receptive emulsion (220) is configured to pull or wick any ink applied to the coating formed by the emulsion to the emulsion/film interface to maximize image quality formed by the ink. Exemplary methods of forming the above-mentioned label (120) will be described in detail below.

Exemplary Label Formation Method

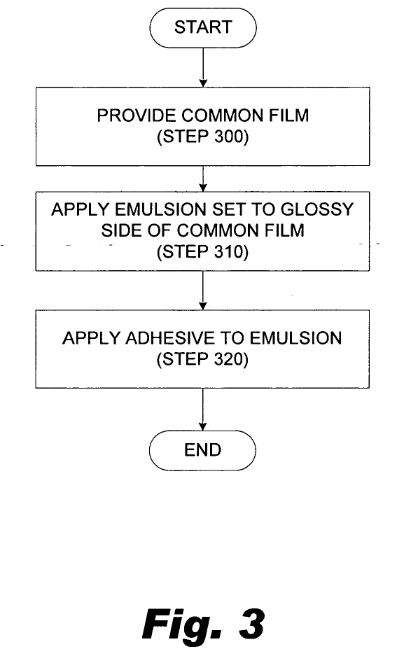

FIG. 3 is a flowchart illustrating a method of forming a matte transparent label, according to one exemplary embodiment. As illustrated in FIG. 3, the present matte transparent label may be formed by first providing a film base (step 300). Once the desired film base is provided (step 300), the above-mentioned ink receptive emulsion may be applied to the glossy surface of the desired film base (step 310). With the glossy surface of the desired film base coated with the ink receptive emulsion (step 310), an adhesive may be applied to the emulsion (step 320) to aid in the transparent label being coupled to a desired substrate. Further details of the above-mentioned label formation steps will be provided below.

As mentioned, the first step in forming a matte transparent label with the present film and emulsion set is to provide a desired film base (step 300). The desired film base may be a polycarbonate or other similar film including both a smooth clear surface and a slightly textured surface as a result of the film formation.

Once the desired film is provided (step 300), the glossy surface of the desired film base is coated with the ink receptive emulsion (step 310). According to one exemplary embodiment, the glossy surface of the desired film base may be coated with the above-mentioned ink receptive emulsion (step 310) using any number of known coating methods including, but in no way limited to, doctor blade coating, curtain coating, flexographic printing, gravure coating, reverse roll coating, metering rod coating, slot or extrusion coating, immersion coating, air knife coating, and the like.

With the desired ink receptive layer formed, an adhesive may be applied to the ink receptive emulsion (step 320). According to one exemplary embodiment, the adhesive is configured to permanently adhere the present label (120) to a desired substrate after formation. The adhesive material may be chosen from a variety of conventional adhesive materials, e.g., such as thermally activated, pressure sensitive, photo activated, or contact adhesives and the like, provided it is compatible with the components of the ink receptive material and that it contributes, at least in part, to ink receptivity. The term “compatible” is intended to mean that the adhesive material may be dispersed within the image transparent, ink receptive emulsion (220) without substantially altering the image transparency or ink receptivity of the layer formed by the emulsion. According to one exemplary embodiment, the adhesive material may be a thermally activated, hydrophilic, adhesive material such as thermoplastic polyurethanes; polycaprolactone; acrylic copolymers; and combinations thereof. Representative thermally activated adhesive materials include Rovace RTM HP-2931 vinyl acetate/acrylic copolymer (a product of Rohm & Haas Company); Morthane RTM CA-116 urethane resin (a product of Morton International); Tone RTM Polymer P767E biodegradable plastic resin (a product of Union Carbide); Elvax RTM 240 vinyl resin (a product of Dupont Chemicals); and the like. In the instance when the adhesive material is blended into the ink receptive emulsion (220) to form a single layer, preferred adhesive materials are vinyl acetate/acrylic copolymers. In the instance when the adhesive material is coated as a separate layer onto the ink receptive layer, preferred adhesive materials are polycaprolactones. When the adhesive material is coated as a separate layer, the layer typically has a thickness in the range of about 0.5 μm to about 10 82 m. Additionally, according to one exemplary embodiment, one or more barrier layers may be printed prior to the application of an adhesive onto the ink receptive emulsion (220) in order to prevent the ink receptive emulsion from absorbing the adhesive.

Alternatively, according to one exemplary embodiment, a non-compatible adhesive may be dispersed on the ink receptive emulsion after the deposition of an image forming ink, according to one exemplary embodiment. Additionally, no adhesive may be used. Rather, according to yet another exemplary embodiment, the present label (120) may be adhered to a desired substrate, such as an optical disk (120; FIG. 1) using any number of known adhesion methods including, but in no way limited to, lamination, electrostatic attraction, or magnetic attraction.

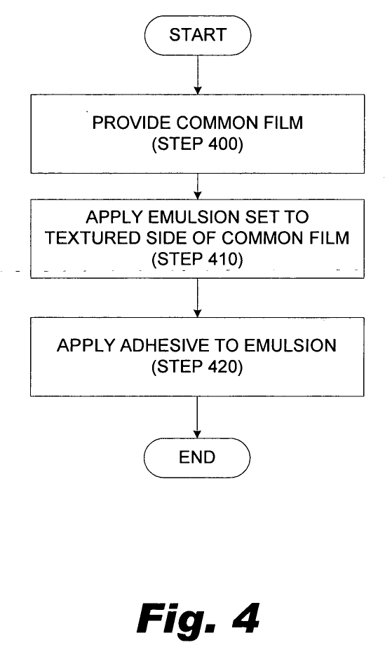

Similar to the exemplary method illustrated in FIG. 3, FIG. 4 illustrates an exemplary method for forming a glossy label using the same substrate and ink receptive emulsion used in FIG. 3, resulting in a matte finish. More specifically, as illustrated in FIG. 4, the exemplary method for forming a glossy label includes providing a desired film base (step 400). Once the desired film base is provided, the above-mentioned emulsion is applied to the textured side of the desired film base (step 410) such that the irregular surface of the textured side is made optically insignificant, and an adhesive may be applied to the emulsion (step 420). More particularly, the ink receptive emulsion is such that it fills irregularities of the textured surface to substantially reduce light diffraction when viewed. Consequently, the film becomes optically clear when viewed from the glossy surface. Additionally, as mentioned with respect to FIG. 3, a barrier layer may optionally be printed prior to the application of an adhesive onto the ink receptive emulsion (220) in order to prevent the ink receptive emulsion from absorbing the adhesive. The ink receptive emulsion may be applied to the textured surface of the desired film by any number of coating processes including, but in no way limited to, doctor blade coating, curtain coating, flexographic printing, gravure coating, reverse roll coating, metering rod coating, slot or extrusion coating, immersion coating, air knife coating, and the like. Particularly, according to one exemplary embodiment, the ink receptive emulsion may be applied to the textured surface by a doctor blade coating process. According to this exemplary embodiment, the metering of the emulsion by the doctor blade apparatus forces the emulsion into the surface irregularities of the film, enhancing the optical clarity of the resulting film.

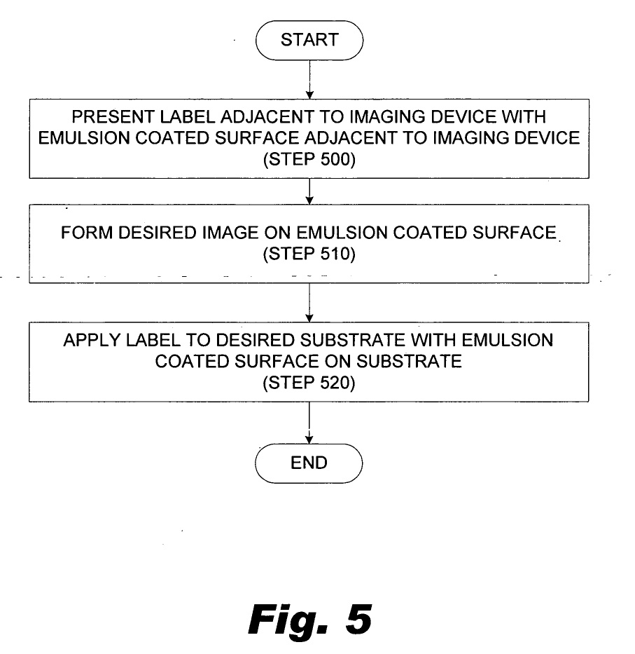

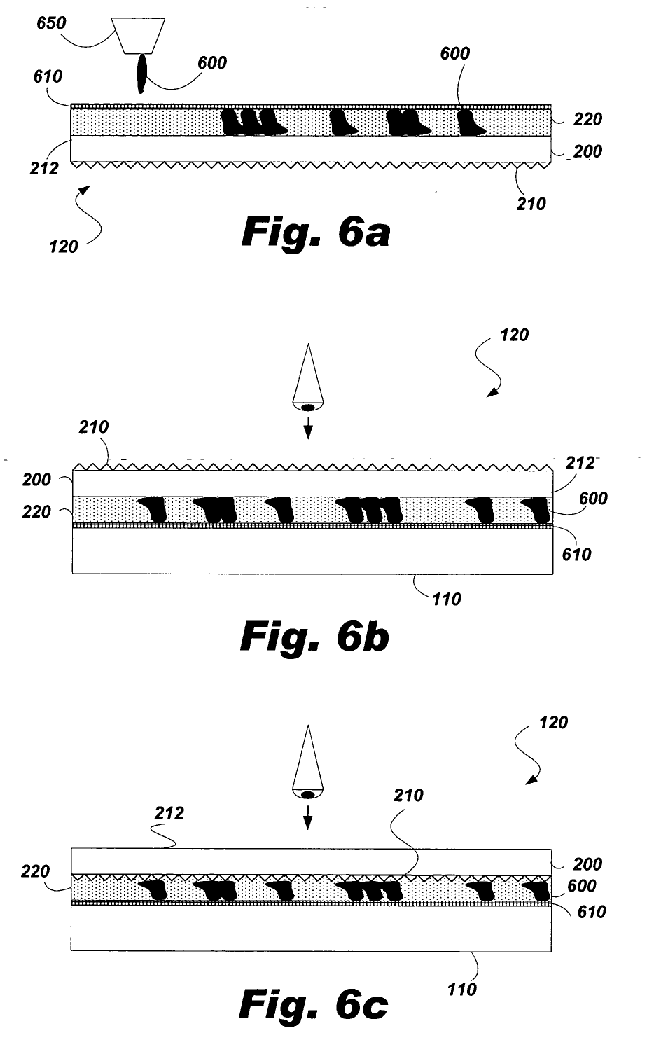

Once the desired label is formed with the above-mentioned film and emulsion set, an image may be formed on the above-mentioned label, according to one exemplary embodiment. FIG. 5 illustrates an exemplary method for forming a desired image on the above-mentioned label, according to one exemplary embodiment. As illustrated, the present exemplary. method for forming a desired image on the above-mentioned label includes first presenting the label adjacent to a desired imaging device with the ink receptive emulsion coated surface adjacent to the imaging device (step 500). With the ink receptive emulsion coated surface adjacent to the imaging device, a desired image may then be formed on the emulsion coated surface (step 510). Once the desired image is formed on the emulsion coated surface, the label may be applied to a desired substrate with the emulsion coated surface contacting the surface of the desired substrate (step 520). Further details of the image formation and label application method will be described in detail below with reference to FIGS. 5 through 6c.

As mentioned previously, the image formation method begins by first presenting the label adjacent to an imaging device with the emulsion coated surface adjacent to the imaging device (step 500). According to one exemplary embodiment, the imaging device used to selectively apply ink to the label to form the desired image may be an inkjet material dispenser. According to this exemplary embodiment, the label may be positioned adjacent to the imaging device by any number of substrate transport mechanisms including, but in no way limited to, belts and/or rollers.

With the label correctly positioned with respect to the imaging device, such as an inkjet material dispenser, the desired image may then be formed on the emulsion coating surface (step 510). As illustrated in FIG. 6a, an inkjet material dispenser (650) may controllably dispense droplets of ink (600) onto the emulsion (220) and adhesive (610) layers, if a compatible adhesive is used, of the present exemplary label (120). Selective deposition of the ink droplets (600) allows a user, among other things, to selectively register an image on the label, and use the imaged object for a variety of purposes such as object identification. According to the present exemplary embodiment, the desired image includes a reversed image, sometimes referred to as a mirror printing, that will be inverted from the desired display.

According to one exemplary embodiment, the inkjet material dispenser (650) used to selectively dispense droplets of ink (600) onto the emulsion (220) layer may include, but is in no way limited to, a mechanically actuated ink-jet dispenser, an electrostatically actuated ink-jet dispenser, a magnetically actuated dispenser, a piezoelectrically actuated dispenser, or a continuous ink-jet dispenser. Alternatively, ink may be applied to the ink reception layer using any number of ink deposition methods including, but in no way limited to, lithographic printing methods.

Returning again to FIG. 5, once the desired image is formed, the label may be applied to a desired substrate with the emulsion coated surface adjacent to the desired substrate (step 520). According to one exemplary embodiment, the label containing a desired image may first be cut or otherwise modified to fit a desired substrate. Once cut or otherwise modified to fit, the label may be applied to the desired substrate using any number of placement guides and/or jigs.

Application of the label to a desired substrate includes placing the emulsion coated surface adjacent to the desired substrate to provide protection for the formed image. Traditionally, printed labels included a protective coating formed on the labels to protect previously formed images. However, the structure of the present exemplary label provides a protective layer. As illustrated in FIGS. 6b and 6c, application of the ink receptive emulsion (220), ink (600), and adhesive (610) to the back side of the film (200) allows the film to act as a protective coating when applied to a desired substrate (110).

As mentioned previously, the layer formed by the ink receptive emulsion (220) is configured to draw deposited ink towards the interface between the ink receptive emulsion layer and the film (200). As illustrated in FIG. 6b, an image is printed on a matte label. The ink (600) is drawn to the smooth side (212) of the film (200). Consequently when viewed, light is slightly diffracted by the irregularities in the textured surface (210) of the film (200), producing the matte finish, while allowing for viewing of the formed image.

Similarly, as illustrated in FIG. 6c, the layer formed by the ink receptive emulsion (220) draws the selectively deposited ink (600) towards the film interface. As shown, the ink receptive emulsion (220) fills in the irregularities of the textured surface so that when printed, a clear, sharp image is viewed from the glossy surface side.

In conclusion, the present exemplary label incorporates a single set of components to form either a glossy or matte finish. By producing either glossy or matte finish with a single component set, cost reductions and quicker time to market are enabled. Specifically, cost is reduced due to lower material costs and a reduction in inventory through the conversion process. Additionally, time to market is improved due to reduced time to procure and qualify one set of film and emulsion rather than multiple sets of film and emulsion for different surface finishes.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. A method of making a label comprising:
providing a film having a smooth surface and a textured surface; and
selectively coating one surface of said film with an ink receptive emulsion to form a glossy or a matte label.

2. The method of claim 1, wherein selectively coating said film comprises selectively coating said textured surface with an ink receptive emulsion to form a glossy label.

3. The method of claim 1, wherein selectively coating said film comprises selectively coating said smooth surface with an ink receptive emulsion to form a matte label.

4. The method of claim 1, wherein said ink receptive emulsion comprises hydrophilic polymers or resins.

5. The method of claim 4, wherein said hydrophilic polymers or resins comprise one of polyvinyl alcohols, polyvinyl pyrrolidones, vinyl pyrrolidone/vinyl acetate copolymer, vinyl acetate/acrylic copolymers, acrylic acid polymers, acrylic acid copolymers, copolymers, acrylamide polymers, acrylamide copolymers, cellulosic polymers, cellulosic copolymers, styrene copolymers, alkylene oxide polymers, alkylene oxide copolymers, gelatins, modified gelatins, or polysaccharides.

6. The method of claim 1, wherein said film comprises one of a polycarbonate based film, a polyester based film, a polypropylene based film, or a cellulose acetate based film.

7. The method of claim 1, wherein said selectively coating said film with said ink receptive emulsion comprises coating a selected side of said film with one of a doctor blade coater, a curtain coater, a flexographic printer, a gravure coater, a reverse roll coater, a metering rod coater, a slot coater, an extrusion coater, an immersion coater, or an air knife coater.

8. The method of claim 1, further comprising selectively dispensing ink onto said ink receptive emulsion to form a reversed desired image.

9. The method of claim 8, further comprising dispensing an adhesive on said ink receptive emulsion.

10. The method of claim 9, further comprising coupling said imaged label to a desired substrate;
wherein coupling said imaged label to a desired substrate comprises joining said ink receptive emulsion layer of said label to a desired substrate with an adhesive.

11. The method of claim 10, wherein said desired substrate comprises an optical disc.

12. A system for selectively forming a glossy or a matte label comprising:
an semi-opaque or transparent film including a smooth surface and a textured surface opposing said smooth surface; and
a hydrophilic ink receptive emulsion configured to be coated on at least one side of said semi-opaque or transparent film;
wherein said film is configured to form a glossy label when said textured surface is coated with said hydrophilic ink receptive emulsion; and
wherein said film is configured to form a matte label when said smooth surface is coated with said hydrophilic ink receptive emulsion.

13. The system of claim 12, wherein said semi-opaque or transparent film comprises an extruded polycarbonate based film, a polyester based film, a polypropylene based film, or a cellulose acetate based film.

14. The system of claim 12, wherein said ink receptive emulsion comprises hydrophilic polymers or resins.

15. The system of claim 14, wherein said hydrophilic polymers or resins comprise one of polyvinyl alcohols, polyvinyl pyrrolidones, vinyl pyrrolidone/vinyl acetate copolymer, vinyl acetate/acrylic copolymers, acrylic acid polymers, acrylic acid copolymers, copolymers, acrylamide polymers, acrylamide copolymers, cellulosic polymers, cellulosic copolymers, styrene copolymers, alkylene oxide polymers, alkylene oxide copolymers, gelatins, modified gelatins, or polysaccharides.

16. The system of claim 12, further comprising an adhesive disposed on said ink receptive emulsion.

17. The system of claim 12, wherein said ink receptive emulsion comprises an ink jettable ink receptive emulsion.

18. A method of forming a label comprising:
providing a semi-opaque or transparent film having a smooth surface
and a textured surface;
providing an ink receptive coating;
determining whether a glossy label or a matte label is desired;
if a glossy label is desired, coating said textured surface with said ink receptive coating; and
if a matte label is desired, coating said smooth surface with said ink receptive coating.

19. The method of claim 18, further comprising selectively dispensing ink onto said ink receptive emulsion to form a reversed desired image.

20. The method of claim 18, further comprising dispensing an adhesive onto said ink receptive emulsion.

21. The method of claim 18, wherein said ink receptive emulsion comprises hydrophilic polymers or resins.

22. A label comprising:
an semi-opaque or transparent film including a smooth surface and a textured surface opposing said smooth surface; and
a hydrophilic ink receptive emulsion coating said textured surface;
wherein said label comprises a glossy label.

23. The label of claim 22, wherein said label further comprises an adhesive layer coupled to said hydrophilic ink receptive emulsion.

24. The label of claim 22, further comprising a reversed ink image disposed in said hydrophilic ink receptive emulsion.

25. The label of claim 22, wherein said semi-opaque or transparent film comprises one of a polycarbonate based film, a polyester based film, a polypropylene based film, or a cellulose acetate based film.

26. The label of claim 22, wherein said hydrophilic ink receptive emulsion comprises a hydrophilic polymer or resins.

27. The label of claim 26, wherein said hydrophilic polymers or resins comprise one of polyvinyl alcohols, polyvinyl pyrrolidones, vinyl pyrrolidone/vinyl acetate copolymer, vinyl acetate/acrylic copolymers, acrylic acid polymers, acrylic acid copolymers, copolymers, acrylamide polymers, acrylamide copolymers, cellulosic polymers, cellulosic copolymers, styrene copolymers, alkylene oxide polymers, alkylene oxide copolymers, gelatins, modified gelatins, or polysaccharides.

28. A label comprising:
an semi-opaque or transparent film including a smooth surface and a textured surface opposing said smooth surface; and
a hydrophilic ink receptive emulsion coating said smooth surface;
wherein said label comprises a matte label.

29. The label of claim 28, wherein said label further comprises an adhesive layer coupled to said hydrophilic ink receptive emulsion.

30. The label of claim 28, further comprising a reversed ink image disposed in said hydrophilic ink receptive emulsion.

31. The label of claim 28, wherein said semi-opaque or transparent film comprises one of a polycarbonate based film, a polyester based film, a polypropylene based film, or a cellulose acetate based film.

32. The label of claim 28, wherein said hydrophilic ink receptive emulsion comprises a hydrophilic polymer or resins.

33. The label of claim 32, wherein said hydrophilic polymers or resins comprise one of polyvinyl alcohols, polyvinyl pyrrolidones, vinyl pyrrolidone/vinyl acetate copolymer, vinyl acetate/acrylic copolymers, acrylic acid polymers, acrylic acid copolymers, copolymers, acrylamide polymers, acrylamide copolymers, cellulosic polymers, cellulosic copolymers, styrene copolymers, alkylene oxide polymers, alkylene oxide copolymers, gelatins, modified gelatins, or polysaccharides.
